(19) United States
(12) Patent Application Publication
(10) Pub. No.: US 2025/0190153 A1
(43) Pub. Date: Jun. 12, 2025

(54) IMAGE FORMING APPARATUS AND METHOD FOR CALLING SETTING VALUES

(71) Applicant: SHARP KABUSHIKI KAISHA, Sakai City (JP)

(72) Inventor: SHO KAMIHISA, Sakai City (JP)

(21) Appl. No.: 18/964,850

(22) Filed: Dec. 2, 2024

(30) Foreign Application Priority Data
Dec. 12, 2023 (JP) 2023-209594

(51) Int. Cl. G06F 3/12

(52) U.S. Cl. CPC G06F 3/1205; G06F 3/1255; G06F 3/1257; G06F 3/1258

(57) ABSTRACT

An image forming apparatus includes a display, one or more storages, and one or more controllers. The display displays an execution screen on which first setting values related to execution of a job have been reflected. The one or more storages store therein second setting values related to execution of the job as a batch setting. The one or more controllers execute the job based on the batch setting. If any of the first setting values have been changed to third setting values before a calling instruction to call the batch setting is given, the one or more controllers display a confirmation screen presenting an inquiry to a user regarding whether or not to discard the third setting values and update the first setting values with the second setting values, and update the first setting values with the second setting values or the third setting values based on a result of the inquiry confirmed by the user.

### BACKGROUND OF THE INVENTION

### Field of the Invention

The present disclosure relates to an image forming apparatus and the like.

### Description of the Background Art

Job programs are known as a form of technology that facilitates job setting procedures in image forming apparatuses such as multifunction peripherals.

A job program is a form of technology for permanently storing settings related to a job as a program, and refers to a batch setting for collectively registering setting values related to job processing. Users can reduce the number of steps involved in executing a job by calling a registered job program.

With regard to calling a registered job program, for example, a conventional technology is known in which if a registered program is called after a user has configure any of settings related to a job, the settings configured by the user are overwritten with settings contained in the program.

An object of the present disclosure is to provide an image forming apparatus and the like that offers excellent operability to users with respect to setting value calling.

### SUMMARY OF THE INVENTION

In order to achieve the object described above, an image forming apparatus according to the present disclosure has the following characteristics. That is, the image forming apparatus includes: a display that displays an execution screen on which first setting values related to execution of a job have been reflected; one or more storages that store therein second setting values related to execution of the job as a batch setting; and one or more controllers that execute the job based on the batch setting. If any of the first setting values have been changed to third setting values before a calling instruction to call the batch setting is given, the one or more controllers display a confirmation screen presenting an inquiry to a user regarding whether or not to discard the third setting values and update the first setting values with the second setting values, and update the first setting values with the second setting values or the third setting values based on a result of the inquiry confirmed by the user.

Furthermore, a method for calling setting values according to the present disclosure has the following characteristics. That is, the method includes: displaying an execution screen on which first setting values related to execution of a job have been reflected; storing second setting values related to execution of the job as a batch setting; displaying, if any of the first setting values have been changed to third setting values before a calling instruction to call the batch setting is given, a confirmation screen presenting an inquiry to a user regarding whether or not to discard the third setting values and update the first setting values with the second setting values; and updating the first setting values with the second setting values or the third setting values based on a result of the inquiry confirmed by the user.

According to the present disclosure, it is possible to provide an image forming apparatus and the like that offers excellent operability to users with respect to setting value calling.

### BRIEF DESCRIPTION OF THE DRAWINGS

FIG. 1 is an external perspective view for illustrating an overall configuration of a multifunction peripheral according to a first embodiment.

FIG. 2 is a diagram illustrating a functional configuration of the multifunction peripheral according to the first embodiment.

FIG. 3 is a flowchart for explaining a flow of processing according to the first embodiment.

FIG. 4 is a diagram illustrating an operation example according to the first embodiment.

FIG. 5 is a diagram illustrating an operation example according to the first embodiment.

FIG. 6 is a diagram illustrating an operation example according to the first embodiment.

FIG. 7 is a diagram illustrating an operation example according to the first embodiment.

FIG. 8 is a diagram illustrating an operation example according to the first embodiment.

FIG. 9 is a diagram illustrating an operation example according to a second embodiment.

FIG. 10 is a diagram illustrating an operation example according to the second embodiment.

FIG. 11 is a diagram illustrating an operation example according to the second embodiment.

FIG. 12 is a diagram illustrating an operation example according to the second embodiment.

FIG. 13 is a diagram illustrating an operation example according to a third embodiment.

### DESCRIPTION OF THE PREFERRED EMBODIMENTS

The following describes embodiments of the present disclosure with reference to the accompanying drawings. It should be noted that the embodiments described below are merely examples for explaining the present disclosure, and the technical content of the description given in the appended claims are not limited to the following description.

Some conventional image forming apparatuses restrict, based on specifications thereof, a registered job program (batch setting) from being called after a user has reconfigured a setting related to a relevant job. Once a user has changed even one setting related to a job in an image forming apparatus with such specifications, the changed setting needs to be reset before a relevant job program is called.

In the case of the aforementioned conventional technology, if a registered program is called after a user has reconfigured any of settings related to a relevant job, the settings reconfigured by the user are overwritten with settings contained in the program. This means that there is a possibility that settings reconfigured by a user might be unintentionally overwritten.

The present disclosure relates to calling of setting values such as a job program registered in an image forming apparatus, and implements an image forming apparatus and the like that offers excellent operability to users through the following embodiments.

### 1. First Embodiment

A first embodiment is configured to present an inquiry to a user of an image forming apparatus regarding whether or not to overwrite and thereby update setting values related to execution of a job with setting values contained in a job program if any of the setting values related to execution of the job have been changed by the user from initial values thereof preset in the image forming apparatus before a calling instruction to call the job program is given, and thus determine whether to update the setting values related to execution of the job based on the setting values contained in the job program or to update (change) the setting values related to execution of the job based on the setting values obtained as a result of the user changing the initial values.

### 1.1. Functional Configuration

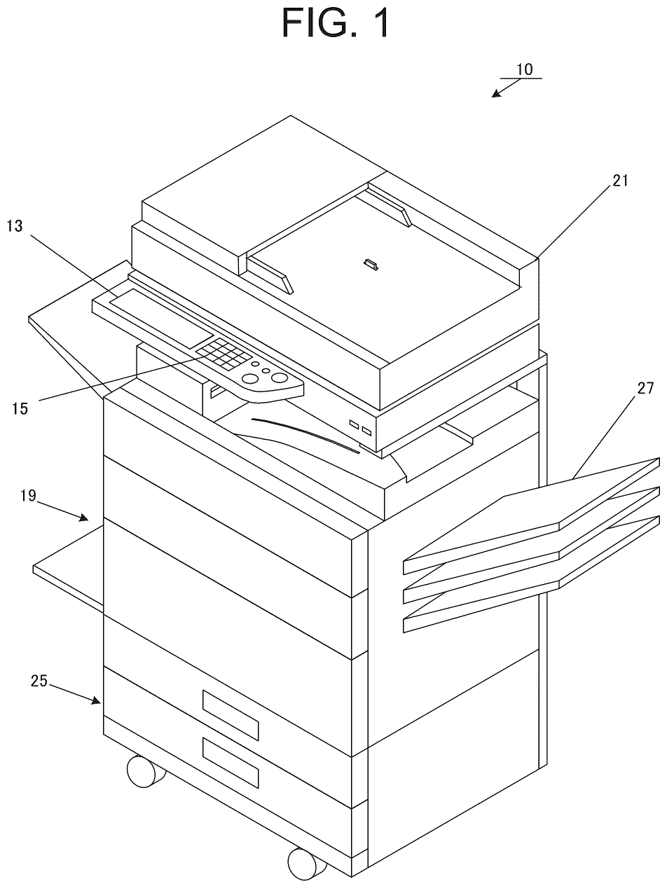

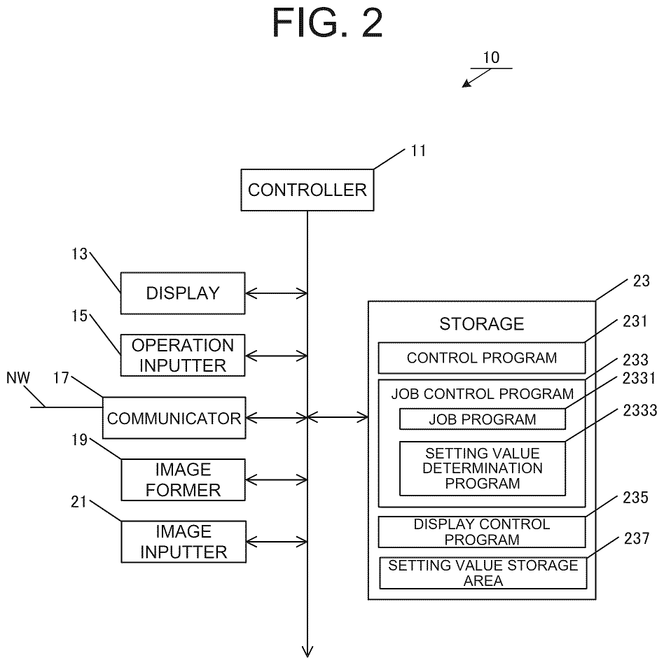

FIG. 1 is an external perspective view for illustrating an overall configuration of a multifunction peripheral 10, which is an image forming apparatus according to the first embodiment. FIG. 2 is a diagram illustrating a functional configuration of the multifunction peripheral 10. The multifunction peripheral 10 is an example of an image forming apparatus capable of performing various types of jobs, such as print, copy, fax, and image transmission jobs, in a single housing. Although the first embodiment is described using an example in which the image forming apparatus is the multifunction peripheral 10, the image forming apparatus is not particularly limited as such, and may be an image forming apparatus designed exclusively for a specific type of job function, such as a printer, a copier, or a fax machine, as long as the image forming apparatus is capable of collectively registering setting values related to job processing as a job program.

The multifunction peripheral 10 includes a controller 11, a display 13, an operation inputter 15, a communicator 17, an image former 19, an image inputter 21, and a storage 23.

The controller 11 performs overall control of the multifunction peripheral 10. The controller 11 includes one or more processing devices (for example, a central processing unit (CPU) and a System on Chip (SoC)). The controller 11 reads and executes various programs stored in the storage 23, and thus implements functions thereof.

The display 13 is a display device that displays various information to, for example, a user. The display 13 may include, for example, a liquid crystal display (LCD) or an organic electro-luminescence (EL) display. The display 13 displays screens such as a job execution screen as an execution screen for executing a job as described below.

The operation inputter 15 is an input device that receives input of information, an operation, an instruction, and the like from, for example, a user. The operation inputter 15 may include, for example, operation keys, such as hardware keys or software keys, and various input devices, such as buttons. It should be noted that the operation inputter 15 can be configured as a touch panel that allows input through the display 13. The operation inputter 15, if configured as a touch panel, can detect the user's touch operations on display objects displayed through the display 13. The touch panel may adopt, for example, a common input method such as a resistive method, an infrared method, an electromagnetic induction method, or a capacitive method.

The communicator 17 includes, for example, either or both of a wired interface and a wireless interface to communicate with other devices (for example, an external terminal device, not shown) via s network NW such as a local area network (LAN), a wide area network (WAN), the Internet, a telephone line, or a facsimile line. Furthermore, the communicator 17 may include, for example, an interface related to a (short-range) wireless communication technique such as Bluetooth (registered trademark), near field communication (NFC), Wi-Fi (registered trademark), ZigBee (registered trademark), infrared data association (IrdA), or wireless universal serial bus (USB).

The image former 19 feeds recording paper from a paper feed tray 25, forms an image based on image information on the recording paper, and then discharges the recording paper to a paper discharger 27. The image former 19 may include, for example, an electrophotographic laser printer. In this case, the image former 19 forms images using toners supplied from toner cartridges, not shown, corresponding to respective toner colors (for example, cyan, magenta, yellow, and black).

The image inputter 21 generates image information by scanning a document. The image inputter 21 may be, for example, configured as a scanner device that includes an image sensor such as a charge coupled device (CCD) or a contact image sensor (CIS) and has an automatic document feeder (ADF), a flatbed, on which the document is placed and read, and the like. No particular limitations are placed on the configuration of the image inputter 21 as long as the image inputter 21 is configured to generate image information by reading light reflected from a document image using an image sensor. It should be noted that the image inputter 21 may be, for example, configured as an interface capable of acquiring document data stored in an external storage medium such as USB memory or a print job transmitted from an external terminal device.

The storage 23 includes one or more storage devices that store therein various programs necessary for operation of the multifunction peripheral 10 and various types of data. The storage 23 may include, for example, storage devices such as random access memory (RAM), a hard disk drive (HDD), a solid state drive (SSD), and read only memory (ROM).

In the first embodiment, the storage 23 stores therein a control program 231, a job control program 233, and a display control program 235. In the storage 23, a setting value storage area 237 is reserved.

The controller 11 reads the control program 231 when comprehensively controlling the multifunction peripheral 10. The controller 11 that has read the control program 231 controls driving of hardware such as the display 13, the operation inputter 15, the communicator 17, the image former 19, and the image inputter 21.

The controller 11 reads the job control program 233 when executing a job related to printing, copying, faxing, or image transmission. The controller 11 that has read the job control program 233 shifts to a job mode for executing a desired job (print mode, copy mode, fax mode, or image transmission mode) to execute the job. When executing the job, the controller 11 displays, on a touch panel configured as the operation inputter 15 (display 13), a job execution screen for receiving selection of a setting value or a function necessary for the execution of the job from the user as necessary. The controller 11 executes the job based on the setting values and the function received via the job execution screen.

The job control program 233 includes a job program 2331 and a setting value determination program 2333. The controller 11 reads the job program 2331, for example, upon receiving a calling instruction from the user, such as selection of an operation button (calling button) provided on a screen such as a job execution screen. The controller 11 that has read the job program 2331 executes the job based on setting values stored in the setting value storage area 237. It should be noted that in the present disclosure, setting values that are stored when the job program 2331 is registered and applied when the job program 2331 is executed are referred to as second setting values.

The controller 11 reads the setting value determination program 2333 in response to a calling instruction to call the job program 2331. The controller 11 that has read the setting value determination program 2333 determines whether or not the setting values reflected when the job execution screen is displayed have been changed through a user's operation such as input or selection. It should be noted that in the present disclosure, the setting values (initial values or default values) reflected when the job execution screen is displayed are referred to as first setting values. First setting values that have been changed to different setting values as a result of a user's operation such as input or selection performed via the job execution screen are referred to as third setting values.

The controller 11 reads the display control program 235 when controlling the display of screens such as the job execution screen by adjusting, for example, the display position or the display size of the content to be displayed on the touch panel. The controller 11 that has read the display control program 235 performs a control to display, for example, input objects for receiving input of various setting values from the user, selection objects for receiving selection of, for example, a setting value or a function, and display objects for displaying a screen such as a confirmation screen, which is described below.

In the setting value storage area 237, for example, first setting values related to job execution (updated setting values if the first setting values have been updated with second setting values or third setting values) and second setting values are stored. The setting values stored in the setting value storage area 237 are, for example, read as appropriate by the controller 11 that has read the job control program 233 and are used for job execution.

### 1.2. Flow of Processing

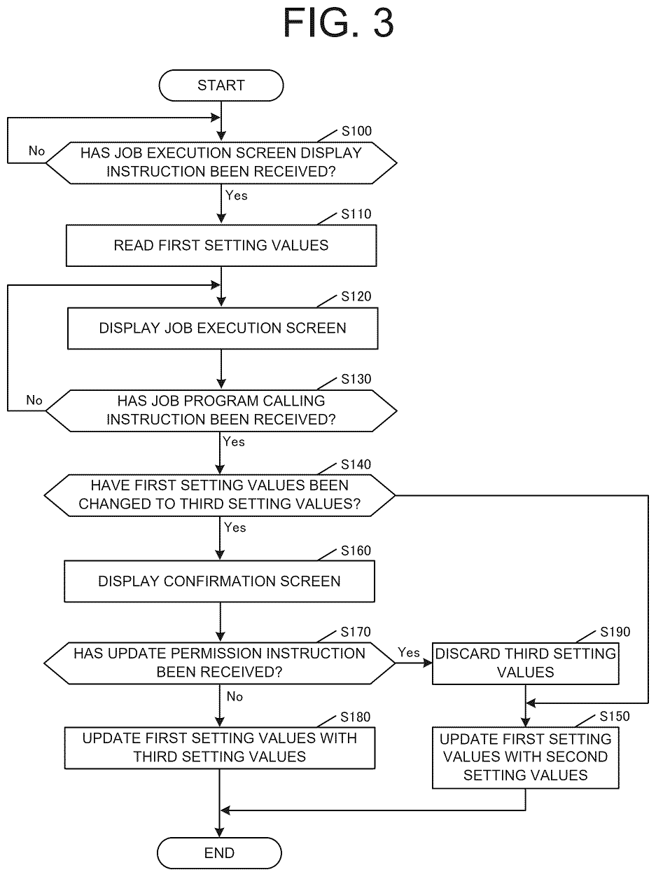

The following describes a flow of processing according to the first embodiment with reference to the flowchart shown in FIG. 3. The processing described with reference to FIG. 3 is executed through the controller 11 reading programs such as the control program 231, the job control program 233 (job program 2331 and setting value determination program 2333), and the display control program 235.

First, the controller 11 determines whether or not a job execution screen display instruction to display a job execution screen related to a job such as a print job, a copy job, a fax job, or an image transmission job has been received (Step S100). Upon determining that a job execution screen display instruction has been received, the controller 11 reads first setting values related to execution of the job from the setting value storage area 237 (Yes in Step S100-->Step S110).

The controller 11 then displays, on the touch panel, a job execution screen on which the read first setting values have been reflected (Step S120). Upon determining that a job execution screen display instruction has not been received, the controller 11 waits until a job execution screen display instruction is received (No in Step S100).

After displaying the job execution screen, the controller 11 determines whether or not a calling instruction to call a job program 2311 has been received from the user (Step S130). Upon determining that a calling instruction to call a job program 2311 has been received from the user, the controller 11 determines whether or not any of the first setting values have been changed to third setting values by the user (Yes in Step S130-->Step S140). Upon determining that a calling instruction to call a job program 2311 has not been received from the user, the controller 11 continues to display the job execution screen (No in Step S130-->Step S120).

Upon determining that none of the first setting values have been changed to third setting values by the user, the controller 11 updates the first setting values with second setting values, which are setting values contained in the job program 2331, and ends the processing (No in Step S140-->Step S150).

Upon determining that one or more of the first setting values have been changed to third setting values by the user, the controller 11 displays, on the touch panel, a confirmation screen presenting an inquiry to the user regarding whether or not to discard the third setting values and update the first setting values with the second setting values (Yes in Step S140-->Step S160).

Then, the controller 11 determines whether or not an instruction to permit updating the first setting values with the second setting values (update permission instruction) has been received from the user (Step S170). Upon determining that an update permission instruction has not been received (No in Step S170), the controller 11 determines not to update (change) the first setting values with (to) the second setting values and determines to update (change) the first setting values with (to) the third setting values. Then, the controller 11 updates (changes) the first setting values with (to) the third setting values (Step S180) and ends the processing.

Upon determining that an update permission instruction has been received, the controller 11 determines to update the first setting values with the second setting values, and discards the third setting values obtained as a result of changing the first setting values (Yes in Step S170-->Step S190). The controller 11 then updates the first setting values with the second setting values (Step S150) and ends the processing. In a case where the first setting values are updated with the second setting values, all of the first setting values are updated with the second setting values. However, in a case where the first setting values are updated with the third setting values, first setting values that have not been changed to third setting values do not necessarily have to be updated.

### 1.3. Operation Example

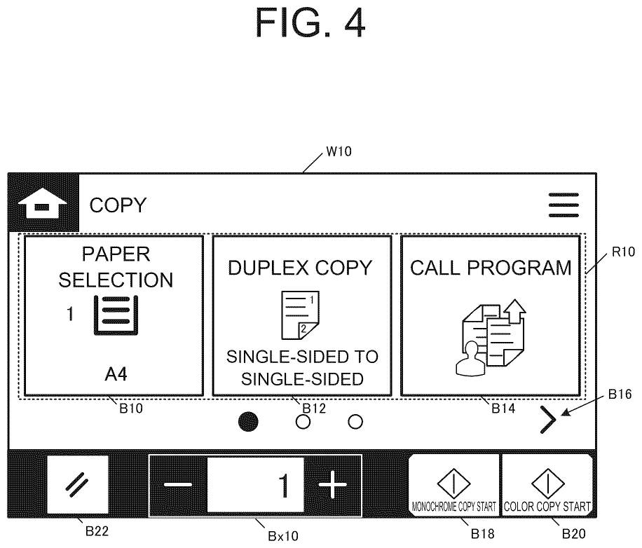

Next, the following describes an operation example according to the first embodiment. FIG. 4 is a diagram illustrating an example of a display configuration of a copy job execution screen W10, which is an example of the job execution screen. The copy job execution screen W10 is a job execution screen for execution of a copy job and receives selection of a setting value or a function necessary for the job execution from the user. The copy job execution screen W10 can be displayed, for example, by selecting a transition instruction button provided on a home screen or other screen, not shown, for an instruction to transition to the copy mode.

The copy job execution screen W10 includes a function menu area R10, a setting button switching button B16, a monochrome copy start button B18, a color copy start button B20, a number of copies input box Bx10, and a reset button B22.

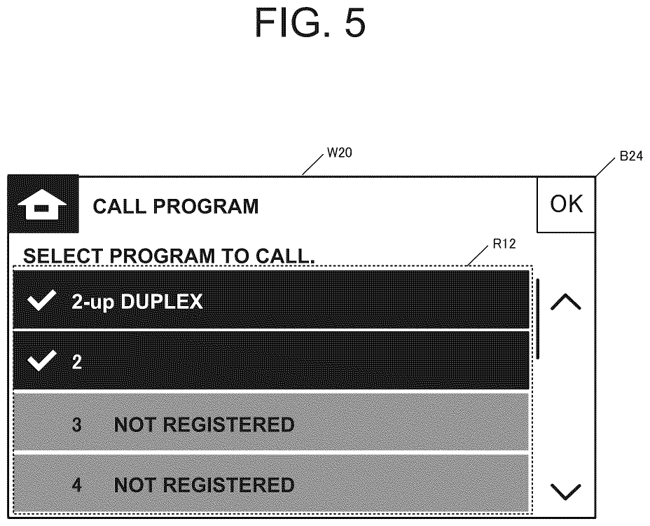

The function menu area R10 includes setting buttons for receiving input, selection, or other operation of setting values for various setting items related to execution of a copy job. FIG. 4 shows, as an example of the setting buttons, a paper selection button B10, a duplex copy button B12, and a program call button B14 displayed in the function menu area R10. Note here that the paper selection button B10 is provided to receive selection of paper to be used for copying. The duplex copy button B12 is provided to receive selection of a duplex copy operation mode (for example, single-sided to single-sided or single-sided to double-sided). The program call button B14 is provided to receive a calling instruction to call a job program 2331 from the user. Upon the user selecting the program call button B14, the controller 11 displays a job program selection screen, which is described with reference to FIG. 5, and calls a registered job program 2331 selected by the user. The setting buttons to be displayed in the function menu area R10 are not limited to the paper selection button B10, the duplex copy button B12, and the program call button B14, and may further include, for example, setting buttons such as a button for a reading setting related to reading of a document image and a button for a finishing setting such as stapling option.

FIG. 4 shows an example of the copy job execution screen W10, which is displayed by the controller 11 by reflecting the first setting values as the initial values (default) upon the user inputting a display instruction to display the job execution screen. In FIG. 4, a setting value “A4” is displayed in a display area of the paper selection button B10 and “single-sided to single-sided” is displayed in a display area of the duplex copy button B12 as examples of the first setting values. The first setting values corresponding to the respective setting buttons can be displayed by sequentially switching setting buttons to be displayed in the function menu area R10 by selecting the setting button switching button B16.

The monochrome copy start button B18 is provided to receive an instruction to execute monochrome image copying. The color copy start button B20 is provided to receive an instruction to execute color image copying. Upon receiving an instruction indicating selection of the monochrome copy start button B18 or the color copy start button B20, the controller 11 executes the job related to copying.

The number of copies input box Bx10 is provided to receive input of the number of copies. The reset button B22 is provided to receive a reset instruction to reset selection of a setting value or a function received on the copy job execution screen W10. Upon receiving an instruction indicating selection of the reset button B22 from the user, the controller 11 resets selection of a setting value or a function received.

FIG. 5 is a diagram illustrating an example of a display configuration of a job program selection screen W20, which is displayed by the controller 11 upon the user selecting the program call button B14. The job program selection screen W20 includes a job program selection area R12 and an OK button B24.

The job program selection area R12 is a display area for displaying registered job programs 2331 in a selectable manner. In an example shown in FIG. 5, two registered job programs 2331 are displayed in the job program selection area R12. Each job program 2331 may be assigned a title (program name) so as to be distinguishable from other job programs 2331. FIG. 5 shows that two job programs 2331, “2-up duplex” as job program 1 and “no title” as job program 2, have been registered.

The OK button B24 is provided to receive a confirmation instruction indicating confirmation of the job program 2331 selected in the job program selection area R12. Upon the user selecting the OK button B24 after selecting at least one of the job programs 2331 displayed in the job program selection area R12, the controller 11 executes processes in Step S130 and the subsequent steps shown in FIG. 3 for calling the selected job program 2331.

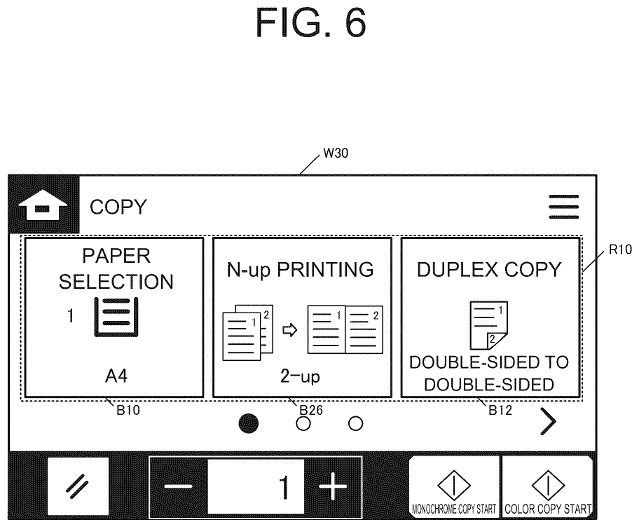

FIG. 6 is a diagram illustrating an operation example corresponding to the processes in the case of “No in Step S140-->Step S150” in FIG. 3 where the controller 11 determines that none of the first setting values have been changed to third setting values by the user, and illustrating an example of a display configuration of a copy job execution screen W30 in which the first setting values have been updated with the second setting values, which are setting values contained in the job program 2331.

Referring to FIG. 6, the following describes a case where the user has selected the job program 2331 named “2-up duplex” on the job program selection screen W20 shown in FIG. 5.

If none of the first setting values have been changed by the user on the copy job execution screen W10 shown as an example in FIG. 4, the first setting values are updated with the second setting values contained in the job program 2331 named “2-up duplex” (for example, N-up print button B26 (2-up) and duplex copy button B12 (double-sided to double-sided)) in response to the calling instruction to call the job program 2331 named “2-up duplex”.

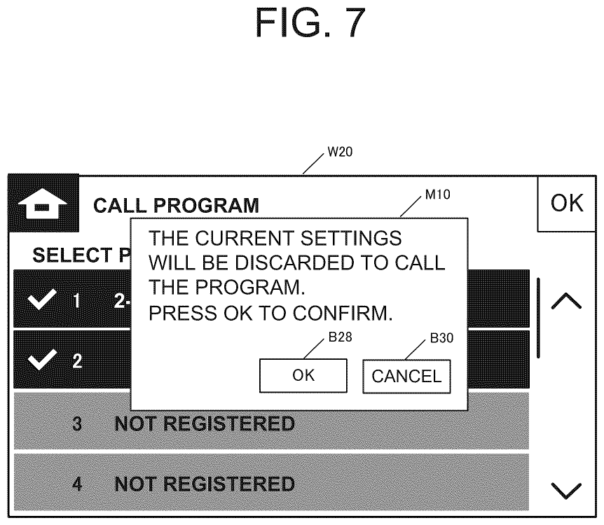

FIG. 7 is a diagram illustrating an operation example corresponding to the processes in the case of “Yes in Step S140-->Step S160” in FIG. 3 where the controller 11 determines that one or more of the first setting values have been changed to third setting values by the user, and illustrating an example of a display configuration of a confirmation screen M10 presenting an inquiry to the user regarding whether or not to discard the third setting values and update the first setting values with the second setting values.

If any of the first setting values have been changed to third setting values (for example, paper selection: from “A4” to “A3”, duplex copy: from “single-sided to single-sided” to “double-sided to single-sided”) by the user on the copy job execution screen W10 shown as an example in FIG. 4, the controller 11 displays the confirmation screen M10 presenting an inquiry regarding whether or not to update the first setting values with the second setting values (N-up printing (2-up), duplex copy (double-sided to double-sided)) contained in the job program 2331 named “2-up duplex” in response to the calling instruction to call the job program 2331 named “2-up duplex”.

The confirmation screen M10 includes, for example, an OK button B28, a cancel button B30, and an inquiry “The current settings (third setting values) will be discarded to call the program. Press OK to confirm.”. The user who has read the inquiry selects the OK button B28 if the user intends to permit the first setting values to be updated with the second setting values contained in the job program 2331. Upon receiving an instruction indicating selection of the OK button B28 from the user, the controller 11 discards the third setting values set by the user on the copy job execution screen W10 and updates the first setting values with the second setting values (N-up printing (2-up), duplex copy (double-sided to double-sided)) contained in the job program 2331 named “2-up duplex”. The user who has read the inquiry selects the cancel button B30 if the user does not intend to permit the first setting values to be updated with the second setting values contained in the job program 2331. Upon receiving an instruction indicating selection of the cancel button B30 from the user, the controller 11 refrains from updating the first setting values with the second setting values contained in the job program 2331 and maintains the third setting values set by the user on the copy job execution screen W10.

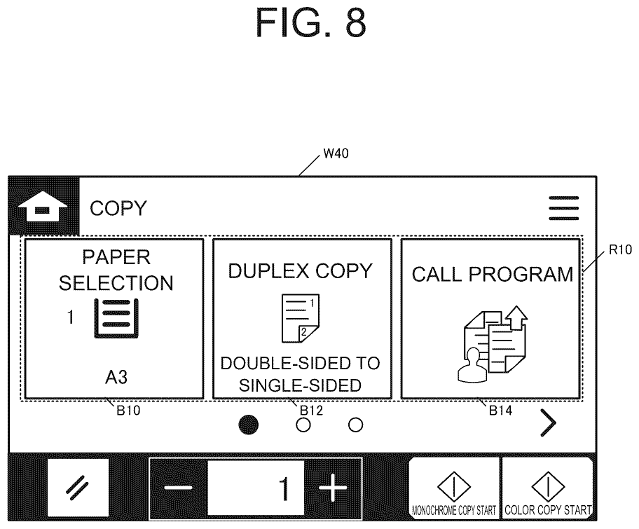

FIG. 8 is a diagram illustrating an example of a display configuration of a copy job execution screen W40, on which the third setting values are maintained, displayed when the controller 11 receives the instruction indicating selection of the cancel button B30 from the user on the confirmation screen M10 shown in FIG. 7.

The copy job execution screen W40 shown in FIG. 8 has the same configuration as the copy job execution screen W10. On the copy job execution screen W40, the third setting values obtained as a result of the user changing the first setting values (for example, paper selection: from “A4” to “A3”, duplex copy: from “single-sided to single-sided” to “double-sided to single-sided”) are maintained.

As described above, the first embodiment is configured to present an inquiry to a user of an image forming apparatus regarding whether or not to overwrite and thereby update setting values related to execution of a job with setting values contained in a job program if any of the setting values related to execution of the job have been changed by the user from initial values thereof preset in the image forming apparatus before a calling instruction to call a job program is given, and thus determine whether to update the setting values related to execution of the job based on the setting values contained in the job program or to update (change) the setting values related to execution of the job based on the setting values obtained as a result of the user changing the initial values. As such, the first embodiment makes it easy to update setting values in job program calling and makes it possible to prevent settings reconfigured by a user from being unintentionally overwritten.

### 2. Second Embodiment

A second embodiment is configured to display, if any of the first setting values have been changed to third setting values by a user in the first embodiment, the thus obtained third setting values (setting items) and receive selection of a desired one of the third setting values to be used instead of a second setting value corresponding to the setting item to update the corresponding first setting value.

A multifunction peripheral 10 according to the second embodiment may have the same functional configuration and the same flow of processing as those described in the first embodiment. Description thereof is therefore omitted here.

### 2.1. Operation Example

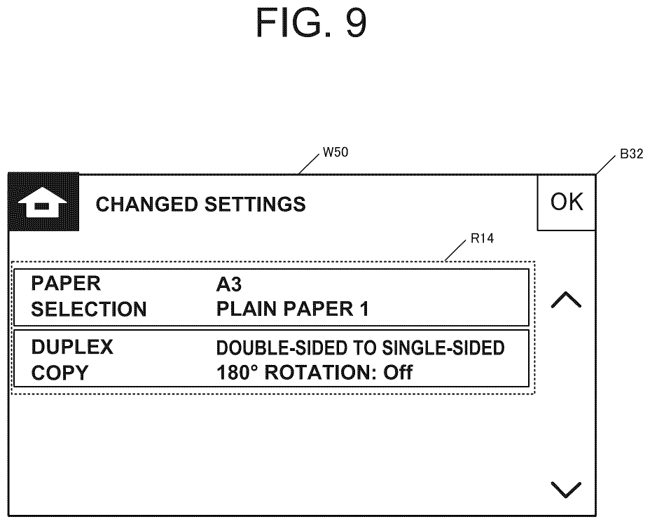

In the second embodiment, upon determining that one or more of the first setting values have been changed to third setting values in the flowchart according to the first embodiment shown in FIG. 3 (Yes in Step S140), the controller 11 displays a changed setting display screen W50 shown as an example in FIG. 9 instead of the confirmation screen M10 (see FIG. 7), which is displayed in Step S160.

FIG. 9 is a diagram illustrating an example of a display configuration of the changed setting display screen W50 of the second embodiment. The changed setting display screen W50 includes a changed setting display area R14 and an OK button B32.

The changed setting display area R14 is a display area for displaying setting items corresponding to the third setting values obtained as a result of the user changing the first setting values. The setting items (third setting values) displayed in the changed setting display area R14 are configured to allow the user to select one or more setting items. FIG. 9 shows an example of the changed setting display area R14 displaying “paper selection” and “duplex copy” as setting items corresponding to the third setting values obtained as a result of the user changing the first setting values.

The OK button B32 is provided to receive an instruction indicating confirmation of selection of one of the setting items corresponding to the third setting values displayed in the changed setting display area R14. Upon the user selecting the setting item “paper selection” and selecting the OK button B32, for example, the controller 11 receives selection of updating the corresponding first setting value with the third setting value for the setting item “paper selection” instead of the second setting value for the setting item “paper selection” contained in the job program 2331.

The controller 11 performs the update in Step S150 shown in FIG. 3 using the third setting value that has been received to be used to update the corresponding first setting value. In this case, the third setting value (setting item) selected in the changed setting display area R14 is excluded from being discarded in Step S190. If the user selects the OK button B32 without selecting any of the setting items displayed in the changed setting display area R14, the controller 11 updates the first setting values with the second setting values.

It should be noted that if the setting item corresponding to the third setting value selected in place of the corresponding second setting value is not combinable with any of the other second setting values contained in the job program 2331, the controller 11 may restrict the selection of the third setting value.

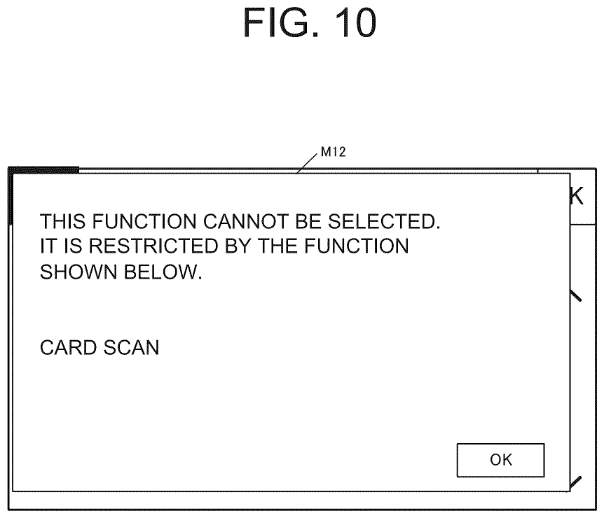

FIG. 10 is a diagram illustrating an example of a display configuration of a notification screen M12. For example, in a case where the user selects “duplex copy” as the setting item corresponding to the desired third setting value in the changed setting display area R14 shown as an example in FIG. 9, the controller 11 displays the notification screen M12 notifying the user that the setting item “duplex copy” cannot be selected because, for example, the setting item “duplex copy” conflicts with a function related to “card scan” or because the setting item “duplex copy” is not combinable with the function related to “card scan” due to specifications.

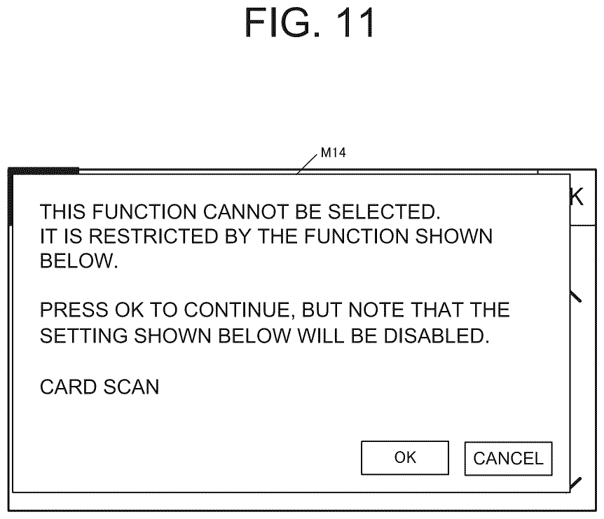

FIG. 11 is a diagram illustrating an example of a display configuration of a notification screen M14 notifying the user, for the same purpose as in FIG. 10, that the function related to “card scan” is disabled if the user selects the setting item corresponding to the desired third setting value (for example, “This function cannot be selected because it is restricted by the function shown below. Press OK to continue, but note that the setting shown below will be disabled. Card scan”).

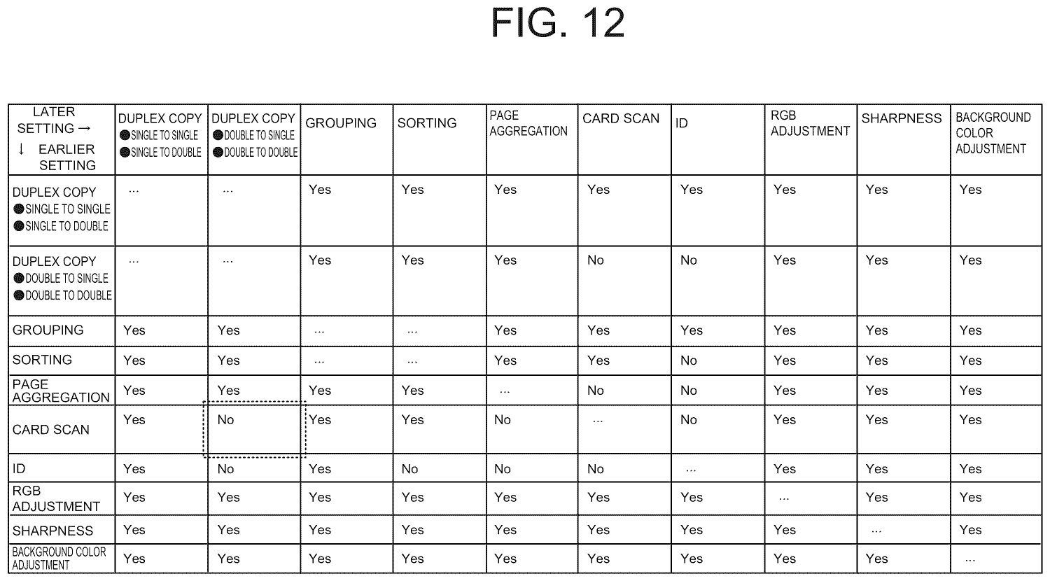

FIG. 12 is a diagram illustrating an example of a data structure of a determination table for the controller 11 to use when determining whether or not the selected setting item corresponding to the desired third setting value is combinable with any of the second setting values contained in the job program 2331 other than the corresponding second setting value.

In FIG. 12, a column labeled “Earlier setting” shows second setting values (setting items) contained in the job program 2331, and a row labeled “Later setting” shows third setting values (setting items). Note here that “Yes” in FIG. 12 means that there is no problem with combining the third setting value (setting item) with the second setting value (setting item), and “No” in FIG. 12 means that the third setting value (setting item) is not combinable with the second setting value (setting item).

For example, if the user selects “duplex copy (double-sided to single-sided)” as a setting item corresponding to the desired third setting value, this selection indicates the combination of “card scan” in the column and “duplex copy” in the row (doted box in FIG. 12). The combination of “duplex copy” as a setting item corresponding to a third setting value and “card scan” as a setting item corresponding to a second setting value is not feasible “No”. That is, these setting items cannot be combined with each other. The controller 11 can determine whether or not a combination of interest of a setting item corresponding to a third setting value and a setting item corresponding to a second setting value is feasible by referring to the determination table shown as an example in FIG. 12.

As described above, the second embodiment allows the user to select a desired third setting value (setting item) to be used instead of the corresponding second setting value to update the corresponding first setting value, and thus produces an effect of achieving more convenient job program calling in addition to the effect that is produced by the first embodiment. If the selected third setting value (setting item) is not combinable with any of the other second setting values (setting items) contained in the job program, the user is notified or the function related to such a second setting value (setting item) is restricted. Thus, the user can perform appropriate job program calling.

### 3. Third Embodiment

A third embodiment is configured to display, in the changed setting display area R14 of the changed setting display screen W50 shown as an example in FIG. 9, setting items to be updated in response to a calling instruction to call a job program 2331 in addition to setting items corresponding to third setting values obtained as a result of the user changing first setting values (second embodiment).

A multifunction peripheral 10 according to the third embodiment may have the same functional configuration and the same flow of processing as those described in the first embodiment and the second embodiment. Description thereof is therefore omitted here.

### 3.1. Operation Example

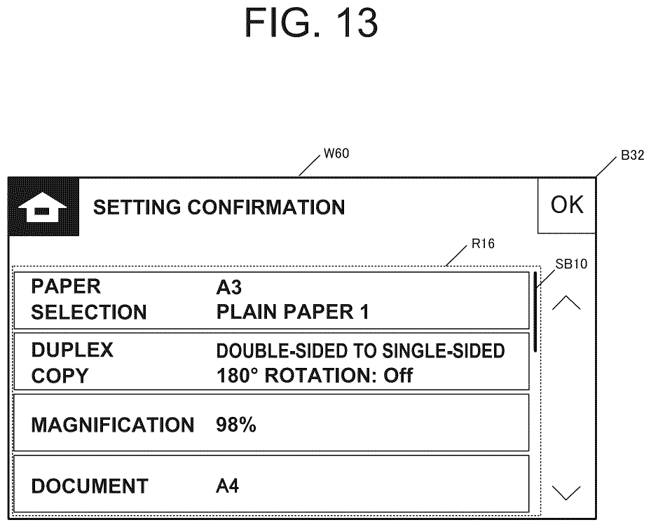

FIG. 13 is a diagram illustrating an example of a display configuration of a changed setting confirmation screen W60 of the third embodiment. The changed setting confirmation screen W60 includes a changed setting display area R16, a scroll bar SB10, and an OK button B32.

The changed setting display area R16 has the same configuration as the changed setting display area R14 shown as an example in FIG. 9, and is a display area for displaying, in addition to setting items corresponding to third setting values obtained as a result of the user changing first setting values (for example, “paper selection” and “duplex copy”), other setting items (for example, “magnification” and “document”) to be updated in response to a calling instruction to call a job program 2331.

If all of the other setting items cannot be displayed within the changed setting display area R16, setting items failing to be displayed can be displayed by scrolling the scroll bar SB10, which is provided at the right end of the changed setting display area R16, downward in FIG. 13.

The controller 11 may display the setting items corresponding to the third setting values obtained as a result of the user changing the first setting values and the other setting items in a distinguishable manner in the changed setting display area R16 by employing different display formats (for example, display font style, display font size, display font color, or frame border). Displaying the setting items corresponding to the third setting values obtained as a result of the user changing the first setting values and the other setting items using different display formats allow the user to easily distinguish the third setting values set by the user from the other setting values to be updated in association with the calling instruction to call the job program 2331.

As described above, the third embodiment is configured to display, in addition to third setting values, other setting values (setting items) to be updated in response to a calling instruction to call a job program, and thus produces an effect of allowing the user to gain a full overview of the setting values (setting items) to be updated in association with the calling instruction to call the job program in addition to the effect that is produced by the second embodiment.

The present disclosure is not limited to the embodiments described above, and various modifications may be made thereto. That is, the technical scope of the present disclosure also includes embodiments that may be obtained by combining technical measures that are modified as appropriate without departing from the gist of the present disclosure.

Although some parts of the above-described embodiments are separately described for convenience of explanation, it is needless to say that the embodiments may be combined and implemented within a technically allowable range.

The program(s) that operates on each device (apparatus) in the foregoing embodiments is a program that controls the CPU or the like (program that causes a computer to function) so as to implement the functions according to the foregoing embodiments. Information that is handled by each device (apparatus) is temporarily accumulated in a temporary storage device (for example, RAM)) during processing, is then stored in various storage devices such as read only memory (ROM) and an HDD, and is read, corrected, and written by the CPU as needed.

A non-transitory computer-readable recording medium in which the program is recorded in an information processing apparatus as referred to herein may be, for example, any of a semiconductor medium (for example, ROM and a non-volatile memory card), an optical recording medium/magneto-optical recording medium (for example, Digital Versatile Disc (DVD)), a Magneto Optical Disc (MO), a Mini Disc (MD), a Compact Disc (CD), and a Blu-ray (registered trademark) Disc (BD)), and a magnetic recording medium (for example, a magnetic tape and a flexible disk). In this case, not only are the functions of the above-described embodiments implemented through the program recorded in the recording medium being read by the computer of the information processing apparatus and executed by the computer, but the functions of the present disclosure may also be implemented through processing performed in cooperation with, for example, an operating system or other application programs based on instructions of the program.

For market distribution, the program may be stored and distributed in a portable recording medium or transferred to a server computer connected via a network such as the Internet. In this case, a storage device of the server computer is obviously included in the present disclosure.

Furthermore, the functional blocks or various features of the device/apparatus used in the embodiments described above may be implemented or executed as an electrical circuit, such an integrated circuit or a plurality of integrated circuits. An electrical circuit designed to implement the functions described herein may include a general-purpose processor, a digital signal processor (DSP), an application-specific integrated circuit (ASIC), a field programmable gate array (FPGA), or other programmable logic devices, discrete gates or transistor logic, discrete hardware components, or a combination of these. The general-purpose processor may be a microprocessor or a conventional processor, controller, microcontroller, or state machine. The electrical circuit described above may be configured by a digital circuit or an analog circuit. Moreover, when an integrated circuit technology that replaces the current integrated circuits emerges as a result of advances in semiconductor technology, one or more aspects of the present disclosure may also use the new integrated circuits based on such technology.

What is claimed is:

1. An image forming apparatus comprising:
a display that displays an execution screen on which first setting values related to execution of a job have been reflected;
one or more storages that store therein second setting values related to execution of the job as a batch setting; and
one or more controllers that execute the job based on the batch setting, wherein
if any of the first setting values have been changed to third setting values before a calling instruction to call the batch setting is given, the one or more controllers
display a confirmation screen presenting an inquiry to a user regarding whether or not to discard the third setting values and update the first setting values with the second setting values, and
update the first setting values with the second setting values or the third setting values based on a result of the inquiry confirmed by the user.

2. The image forming apparatus according to claim 1, wherein the one or more controllers update the first setting values with the second setting values if the result of the inquiry confirmed by the user indicates that the first setting values are to be updated with the second setting values.

3. The image forming apparatus according to claim 1, wherein the one or more controllers update the first setting values with the third setting values if the result of the inquiry confirmed by the user indicates that the first setting values are not to be updated with the second setting values.

4. The image forming apparatus according to claim 1, wherein if any of the first setting values have been changed to the third setting values, the one or more controllers display, to the user, a screen for receiving selection for each of the changed first setting values regarding whether or not to update the changed first setting value with a third setting value corresponding to the changed first setting value instead of a second setting value corresponding to the changed first setting value, and receive the selection regarding whether or not to update the changed first setting value with the third setting value corresponding to the changed first setting value.

5. The image forming apparatus according to claim 4, wherein if the one or more controllers receive selection of updating the changed first setting value with the third setting value corresponding to the changed first setting value, but the third setting value indicated by the received selection is not combinable with any of the second setting values that is other than the second setting value corresponding to the changed first setting value, the one or more controllers restrict the selection of updating the changed first setting value with the indicated third setting value.

6. The image forming apparatus according to claim 5, wherein the one or more controllers display a notification screen notifying that the third setting value indicated by the received selection is not selectable in combination with any of the second setting values that is other than the second setting value corresponding to the changed first setting value.

7. The image forming apparatus according to claim 5, wherein upon receiving the selection of updating the changed first setting value with the third setting value corresponding to the changed first setting value, the one or more controllers notify that a setting corresponding to the second setting values that is other than the second setting value corresponding to the changed first setting value is to be disabled, and perform a control to disable the setting corresponding to the second setting values that is other than the second setting value corresponding to the changed first setting value.

8. The image forming apparatus according to claim 4, wherein the one or more controllers display all of the second setting values stored as the batch setting that is other than the second setting value corresponding to the changed first setting value as well as the third setting values corresponding to the changed first setting values.

9. A method for calling setting values, the method comprising:
displaying an execution screen on which first setting values related to execution of a job have been reflected;
storing second setting values related to execution of the job as a batch setting;
displaying, if any of the first setting values have been changed to third setting values before a calling instruction to call the batch setting is given, a confirmation screen presenting an inquiry to a user regarding whether or not to discard the third setting values and update the first setting values with the second setting values; and
updating the first setting values with the second setting values or the third setting values based on a result of the inquiry confirmed by the user.
